(19) United States
(12) Patent Application Publication
(10) Pub. No.: US 2006/0035056 A1
(43) Pub. Date: Feb. 16, 2006

(54) Multi layered wood panel product and process

(76) Inventor: Stewart G. Fuzzell, Trussville, AL (US)

Correspondence Address: FRANK C. EYMARD;Adams and Reese LLP, 4500 One Shell Square, New Orleans, LA, 70139, US

(21) Appl. No.: 10/915,520

(22) Filed: Aug. 10, 2004

(51) Int. Cl. B32B 5/12

(52) U.S. Cl. 428/105

(57) ABSTRACT

The present invention provides multi layered wood panels and a process for manufacturing the same whereby the multi layered wood panels are mostly indistinguishable from solid lumber and are structurally stable. The multi layered wood panel comprises a first face, a second face and a core layer disposed between the first and second faces. The first face, second face and core layer are comprised of veneer sheets. The veneer sheets comprising the core layer are bonded tight side to tight side and loose side to loose side.

### FIELD OF THE INVENTION

The present invention relates generally to wood panels, and more particularly to wood panels having multiple veneer layers, improved structural stability, and an appearance mostly indistinguishable from solid lumber.

### BACKGROUND OF THE INVENTION

A shortage of resources has forced the prices of good quality solid lumber and products derived therefrom to be high. In response to these high costs, attempts have been made to manufacture wood panels from other less expensive resources. Panels manufactured using less expensive resources typically contain a core layer and two face layers. The core layer is typically comprised of a composite material. The face layers are characteristically comprised of a single rotary cut or strand board veneer sheet, made from the same or a different wood material as the core layer, and are bonded to the core panel to provide an aesthetic finish.

Panels manufactured, as described above, have aesthetic and structural problems. Aesthetically, the edges of the panels lack the appearance of solid lumber. Structurally, lateral expansion of the panel across the grain as the panel absorbs moisture causes some amount of shrinkage, warping, buckling and/or twisting. Another problem, related to changes in moisture, is commonly referred to as checking and has been prevalent in the plywood industry since its inception. Basically, it is caused by a loss of moisture in the face veneer resulting in shrinkage of this component. As the dimensions of the veneer change, stresses are set up between the face and the core. The stresses are nothing more than a restraining action of the more stable core. When these forces reach the point where they exceed the structural strength of the veneer, a rupture of the fiber takes place. This, in effect, shows up as a check or a minute split on the surface of the veneer. These checks naturally follow the weak zones such as lathe checks, pores or splices in the veneer. Factors which affect the degree of checking in face veneers are veneer species, type, thickness and moisture content, as well as, type of core material and construction methods such as number of plies, adhesive, moisture and spread, assembly time and pressing conditions.

The present invention addresses these problems by providing affordable wood panels having the strength, stability, and appearance of solid lumber.

### SUMMARY OF THE INVENTION

The present invention provides multi layered wood panels and a process for manufacturing the same whereby the multi layered wood panels are mostly indistinguishable from solid lumber and are structurally stable. Because the multi layered wood panels are extremely stable and uniform in color, they can be treated as a solid wood product in application. Further, they can be cut to various dimensions not practical with solid lumber.

The present invention is generally comprised of multiple veneer sheets, each having longitudinal grain structures, a tight side and a loose side. In its final form, the multi layered wood panel comprises a first face, a second face and a core layer disposed between the first and second faces. The first and second faces are each comprised of a veneer sheet. The core layer is bonded to the loose sides of the veneer sheets that comprise the first and second faces such that that the tight sides of the veneer sheets that comprise the first and second faces create the outer most surfaces of the multi layered wood panel. The core layer is comprised of a plurality of veneer sheets bonded tight side to tight side and loose side to loose side such that the loose sides of the outer veneer sheets create the outer-most surfaces of the core layer. In one embodiment, all of the veneer sheets comprising the multi layered wood panel are oriented such that the longitudinal grain structures of all of the veneer sheets are parallel to the each other:

The multi layered wood panel offers many yield and cost advantages because it has the appearance of solid lumber—both on the outer surfaces and panel edges—and it can be made from lower grade resources than solid lumber. Additionally, the veneer sheets comprising the first and second faces may be comprised of a higher grade of wood than the veneer sheets comprising the core layer thereby creating the appearance of a high grade piece of solid lumber. Also, the veneer sheets comprising the first face, second face, and core layer may be comprised of the same species of wood or the first and second face may be comprised of a different species of wood than the core layer. The different species of wood that may be used in the first face, second face, and core layer include but are not limited to species such as Red Oak, Cherry, Sycamore, Pecan, Sugarberry, Hackberry and Hard Maple. In many species, the core material can be produced from similar but lower cost, substitute species. Additionally, the multi layered wood panels can be produced to exact dimensions allowing a higher raw material to finished goods ratio than solid lumber, resulting in lower cost finished goods.

The new method of making the above mentioned multi layered wood panel results in a product having good structural properties and aesthetic appeal. Further, the number of steps in producing the product is greatly reduced as compared to conventional methods. In accordance with one preferred embodiment, the method includes the steps of providing multiple veneer sheets produced from a traditional manufacturing process; sorting the veneer sheets by color; removing defects in the veneer sheets that will form the core layer and replacing them with defect-free material; placing the veneer sheets in stacks in the order they will be placed in the final multi layered wood panel (as described in the preceding paragraphs) and allowing equalization of moisture, which allows for a minimization of shrinkage, warping and twisting in the final product; applying an adhesive between the veneer sheets such as a urea based glue mixed with pecan shell flower (the result is a mostly invisible glue line between the veneer sheets on the edge of the grain of the multi layered wood panel); pressing the multi layered wood panel at elevated pressures and temperatures until the adhesive is cured; placing the multi layered wood panels in stacks on flat pallets under pressure for extended periods of time; cutting the multi layered wood panels to desired dimensions; and packaging the multi layered wood panels such that air flow across any surface of the panel is eliminated.

### BRIEF DESCRIPTION OF THE DRAWINGS

FIG. 1 is a perspective view of one embodiment of the multi layered wood panel provided by the present invention with parts broken away for the purpose of illustrating the different layers of the multi layered wood panel.

FIG. 2 is a flow sheet illustrating the steps of an embodiment of the process provided by the invention.

### PREFERRED EMBODIMENTS OF THE INVENTION

In the following detailed description of the preferred embodiments, reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

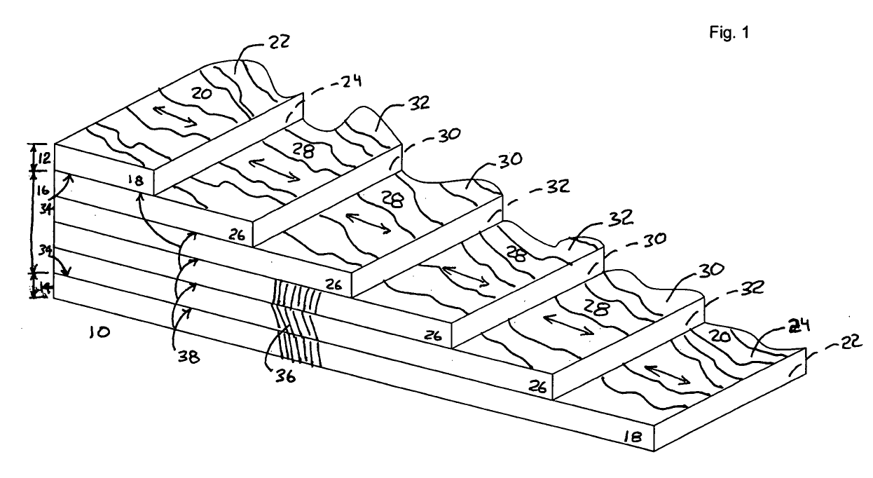

FIG. 1 is a perspective view of one embodiment of multi layered wood panel 10 provided by the present invention having a first face 12, a second face 14 and a core layer 16. The first face 12 and second face 14 are each comprised of a veneer sheet 18 having longitudinal grain structures 20, a tight side 22, and a loose side 24. Tight side 22 is the side of a knife-cut veneer sheet that was farthest away from the knife as the veneer sheet was being cut and contains no cutting checks whereas loose side 24 is the side of the veneer sheet that was in contact with the knife as the veneer sheet was being cut and generally has cutting checks. The bending of the wood at the knife-edge generally causes the cutting checks. Thus, tight side 22 generally has a smoother texture than loose side 24. The veneer sheets 18 that form the first face 12 and second face 14 are oriented such that their longitudinal grain structures 20 are parallel to each other as shown by the directional arrows. The core layer 16 is disposed between and bonded to the loose sides 24 of the veneer sheets 18 comprising the first face 12 and the second face 14. The core layer 16 is comprised of a plurality of veneer sheets 26, each with longitudinal grain structures 28, a tight side 30 and a loose side 32. The veneer sheets 26 are bonded tight side 30 to tight side 30 and loose side 32 to loose side 32 such that the outer surfaces 34 of the core layer 16 are comprised of loose sides 32 and are bonded to the loose sides 24 of the first face 12 and second face 14. In the embodiment shown in FIG. 1, the veneer sheets 26 that comprise core layer 16 are oriented with their longitudinal grain structures 28 parallel to each other and parallel to longitudinal grain structures 20 of veneer sheets 18. The longitudinal grain structures 28 of adjacent veneer sheets 26 forming the core layer 16 may also be positioned perpendicularly, thus providing crossbands.

The veneer sheets 18, comprising first face 12 and second face 14, and the veneer sheets 26, comprising core layer 16, may be made from different qualities or grades of wood, different species of wood, the same species of wood or different combinations thereof. Such species of wood include but are not limited to Red Oak, Cherry, Sycamore, Pecan, Sugarberry, Hackberry and Hard Maple. For example, a high grade wood may be used for veneer sheets 18, comprising first face 12 and second face 14, to improve aesthetic appeal and a lower grade wood may be used for veneer sheets 26, comprising the core layer 16, to lower material costs. Additionally, different species of wood may be used for veneer sheets 18, comprising the first face 12 and second face 14, and veneer sheets 26, comprising core layer 16. For example, veneer sheets 18 may be derived from a Cherry wood and veneer sheets 26 from a Sycamore wood. Or the same species of wood may be used in veneer sheets 18 and veneer sheets 26.

To obtain the appearance of solid wood, veneer sheets 18 and veneer sheets 26 have similar colors and moisture contents. Defective areas in veneer sheets 26 are removed, prior to bonding, using a defect removing method and apparatus commonly used in the industry. The apparatus replaces the defective areas with defect free materials matching the color of the veneer sheet from which the defect was taken. For example, defect free material is typically placed in a cutter type apparatus that is used to cut or punch a hole around the defect and insert the defect free material in the location of the defective material. The result is a uniform color and texture of edge grain 36 in the final finished multi layered wood panel 10 when cut into dimensioned parts.

Veneer sheets 18 and veneer sheets 26 are bonded together with an adhesive comprised of a urea based glue mixed with pecan shell flower. This glue mixture is spread at a preferred weight of approximately 42 to 54 pounds per 1,000 square feet of veneer sheet. The result is an invisible glue line 38 between veneer sheets 18 and veneer sheets 26. The invisible glue line 38 creates a uniform color and texture of edge grain 36 in the final finished multi layered wood panel 10 when cut into dimensioned parts.

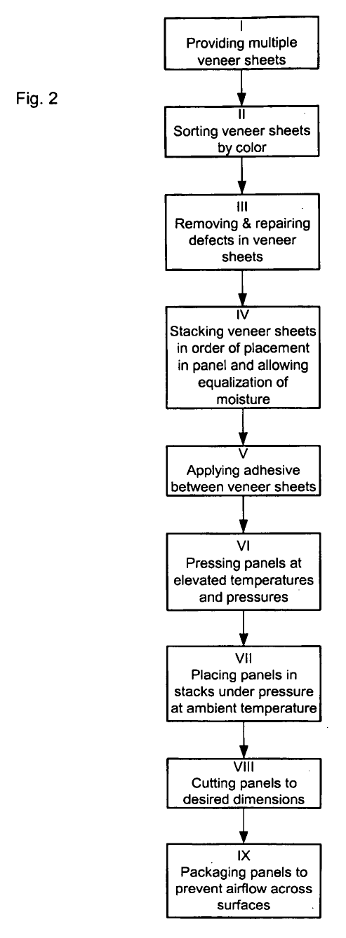

FIG. 2 illustrates the steps of an embodiment of the process provided by the invention. This process may be used to produce the multi layered wood panel illustrated in FIG. 1. Step I involves providing multiple veneer sheets, each having longitudinal grain structures, a tight side and a loose side. The drying specifications of the veneer sheets typically range from 5.5 to 8% moisture content. Step II involves sorting the veneer sheets by color so that veneer sheets of similar color are grouped together for future placement in a multi layered wood panel. Step III involves removing and repairing defects from the veneer sheets that will comprise the core layer of the multi layered panel. Traditional methods, as discussed above, are used to cut defective areas out and replace them with the same material but of a matching color as the veneer sheet from which the defective area was removed. The result is a uniform color and texture of the edge grain of the finished multi layered panel. Step IV involves placing the veneer sheets of similar color in stacks in the order they will appear in the final multi layered wood panel (as illustrated in FIG. 2). The veneer sheets are placed on pallets for approximately 8 to 12 days. This allows for equalization of moisture throughout the multi layered wood panel. The result is a minimization of warping and twisting in the finished multi layered wood panel. Step V involves applying an adhesive between the veneer sheets comprising the multi layered wood panel. The adhesive is comprised of a urea based glue mixed with pecan shell flower or other similar bonding agent. The adhesive is spread over the faces of the veneer sheets at a preferred weight ranging of approximately 42 to 54 pounds per 1000 square feet of veneer sheet but may be spread at other weights. The result is a mostly invisible glue line between the veneer sheets on the edge grain of the panel that gives the appearance of solid wood. Step VI involves pressing the multi layered wood panel at elevated pressures and temperatures whereby a minimum core temperature necessary to cure the adhesive is reached. Press time varies according to the thickness of the multi layered wood panel being pressed. For example, a 1 inch thick panel will typically be pressed at approximately 200 pounds per square inch for approximately 10 minutes at approximately 180 degrees Fahrenheit. Step VII involves placing the multi layered wood panels in stacks on flat pallets under pressure for extended periods of time at about ambient temperature. Typically, the pressed panels are stacked on the flat pallets to a cumulative height of approximately 28 to 36 inches under approximately 100 pounds per square inch of pressure for approximately 9 to 11 days at about ambient temperature. Stack height, pressure, and times may vary depending on the multi layered wood panels and ambient conditions. Step VIII involves cutting the multi layered wood panels to desired dimensions. The multi layered wood panels may be cut to exact dimensions specified. Step IX involves packaging the multi layered wood panel whereby airflow across any surface of the multi layered wood panel is substantially eliminated. Traditional packaging methods such as cellophane shrink wrapping, stretch wrapping or other methods commonly used in the packaging industry may be utilized. The aforementioned steps are typically performed in the order given, but steps II, III and IV may be performed in different sequences. For example, step III may be performed before step II or step IV may be performed before step III.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A multi layered wood panel, comprising:
a first face comprised of a veneer sheet having longitudinal grain structures, a tight side and a loose side;
a second face comprised of a veneer sheet having longitudinal grain structures, a tight side and a loose side, and oriented with the longitudinal grain structures parallel to the longitudinal grain structures of the first face;
a core layer disposed between and bonded to the loose sides of the veneer sheets comprising the first and second faces, where the core layer is comprised of a plurality of veneer sheets, each having longitudinal grain structures, a tight side and a loose side, the veneer sheets of the core layer being bonded tight side to tight side and loose side to loose side.

2. The multi layered wood panel of claim 1, wherein the core layer comprises an even number of veneer sheets such that the outermost surfaces of the core layer are loose sides.

3. The multi layered wood panel of claim 1, wherein the veneer sheets of the core layer are oriented such that the longitudinal grain structures are parallel to each other and parallel to the longitudinal grain structures of the veneer sheets comprising the first and second faces.

4. The multi layered wood panel of claim 1, wherein at least one of the veneer sheets comprising the core layer is oriented such that its longitudinal grain structures are perpendicular to the longitudinal grain structures of the other veneer sheets comprising the core layer.

5. The multi layered wood panel of claim 1, wherein the longitudinal grain structure of each veneer sheet comprising the core layer is oriented perpendicular to the longitudinal grain structures of each adjacent veneer sheet.

6. The multi layered wood panel of claim 1, wherein the veneer sheets comprising the first face, second face and core layer are comprised of the same species of wood.

7. The multi layered wood panel of claim 1, wherein the veneer sheets comprising the first face and second face are comprised of a different species of wood than the veneer sheets comprising the core layer.

8. The multi layered wood panel according to claim 6, wherein the veneer sheets comprising the first face and second face are comprised of a higher grade of wood than the veneer sheets comprising the core layer.

9. The multi layered wood panel according to claim 7, wherein the veneer sheets comprising the first face and second face are comprised of a higher grade of wood than the veneer sheets comprising the core layer.

10. The multi layered wood panel of claim 1, wherein the first face, second face and core layer are comprised of veneer sheets having similar colors and moisture contents.

11. The multi layered wood panel of claim 1, in which the individual veneer sheets comprising the first face, second face and core layer are stacked on pallets, prior to bonding the veneer sheets together, in their order of placement as they will appear in the final multi layered wood panel, until the moisture level in the veneer sheets equalizes.

12. The multi layered wood panel of claim 1, in which the veneer sheets comprising the first face, second face and core layer are bonded together with an adhesive comprised of an urea based glue mixed with pecan shell flower.

13. The multi layered wood panel of claim 12, in which the adhesive is spread at a weight of approximately 42 to 54 pounds per 1000 square feet of veneer sheet.

14. The multi layered wood panel of claim 1, in which defects in the individual veneer sheets comprising the core layer are replaced with defect free material having a similar color as the color of the veneer sheets from which the defect was removed.

15. A method for producing a multi layered wood panel comprising the following steps:
providing multiple veneer sheets, each having longitudinal grain structures, a tight side and a loose side;
sorting the veneer sheets by color;
placing veneer sheets having similar colors in stacks, whereby the veneer sheets are stacked in the order they will appear in the multi layered wood panel, the multi layered wood panel having a first face, a second face and a core layer disposed between the first and second faces and in contact with the loose sides of the first and second faces, the first and second face each comprised of a veneer sheet whereby the longitudinal grain structures of the veneer sheets are oriented parallel to each other, the core layer comprised of a plurality of veneer sheets stacked tight side contacting tight side and loose side contacting loose side;
applying an adhesive between the veneer sheets comprising the multi layered wood panel;
pressing the multi layered wood panel to cure the adhesive;
placing the multi layered wood panels in stacks on flat pallets.

16. The method of claim 15, wherein the veneer sheets comprising the core layer are stacked such that the outer most surfaces of the core layer are loose sides.

17. The method of claim 15, wherein the veneer sheets comprising the core layer are stacked with their longitudinal grain structures oriented parallel to each other and parallel to the longitudinal grain structures of the veneer sheets comprising the first and second faces.

18. The method of claim 15, wherein the veneer sheets comprising the core layer are stacked such that at least one of the veneer sheets comprising the core layer is oriented with its longitudinal grain structures perpendicular to the longitudinal grain structures of the other veneer sheets comprising the core layer.

19. The method of claim 15, wherein each veneer sheet comprising the core layer is oriented perpendicular to the longitudinal grain structures each adjacent veneer sheet.

20. The method of claim 15, further comprising: cutting the multi layered wood panels to desired dimensions.

21. The method of claim 15, further comprising: packaging the multi layered wood panels whereby airflow across any surface of the multi layered wood panel is substantially eliminated.

22. The method of claim 15, further comprising: prior to applying the adhesive, removing and repairing defects in individual veneer sheets comprising the core layer whereby each veneer sheet has a consistent color throughout.

23. The method of claim 15, further comprising: after placing the veneer sheets in the order they will appear in the multi layered wood panel and prior to applying the adhesive, leaving the veneer sheets on pallets for approximately 8 to 12 days.

24. The method of claim 15, wherein the adhesive applied between the veneer sheets is comprised of a urea based glue mixed with pecan shell flower.

25. The method of claim 24, wherein the adhesive is spread at a weight of approximately 42 to 54 pounds per 1000 square feet of veneer sheet.

26. The method of claim 15, wherein the pressing time varies according to the desired finished thickness of the multi layered wood panel.

27. The method of claim 15, wherein the multi layered wood panel is pressed at elevated pressures and temperatures.

28. The method of claim 15, wherein the pressed multi layered wood panels are stacked on a flat pallet under pressure for an extended period of time at about ambient temperature.

29. The method of claim 28, wherein the pressed multi layered wood panels are stacked on a flat pallet to a cumulative height of approximately 28 to 36 inches and placed under approximately 100 pounds per square inch of pressure for approximately 9 to 11 days at about ambient temperature.

30. The multi layered wood panel produced according to the method of claim 15.

31. The multi layered wood panel of claim 28, wherein the veneer sheets comprising the first face, second face and core layer are comprised of the same species of wood.

32. The multi layered wood panel of claim 28, wherein the veneer sheets comprising the first face and second face are comprised of a different species of wood than the veneer sheets comprising the core layer.

33. The multi layered wood panel of claim 29, wherein the veneer sheets comprising the first face and second face are comprised of a higher grade of wood than the veneer sheets comprising the core layer.

34. The multi layered wood panel of claim 30, wherein the veneer sheets comprising the first face and second face are comprised of a higher grade of wood than the veneer sheets comprising the core layer.

35. The multi layered wood panel produced according to the method of claim 22.

36. The multi layered wood panel produced according to the method of claim 23.

37. The multi layered wood panel produced according to the method of claim 24.

38. The multi layered wood panel produced according to the method of claim 25.

39. The multi layered wood panel produced according to the method of claim 26.

40. The multi layered wood panel produced according to the method of claim 27.

41. The multi layered wood panel produced according to the method of claim 28.

42. The multi layered wood panel produced according to the method of claim 29.
